(19) United States
(12) Patent Application Publication
(10) Pub. No.: US 2025/0358164 A1
(43) Pub. Date: Nov. 20, 2025

(54) FREQUENCY CONFIGURATIONS TO COMMUNICATE OVER CABLE INFRASTRUCTURE USING RADIO ACCESS TECHNOLOGY

(71) Applicant: QUALCOMM Incorporated, San Diego, CA (US)

(72) Inventors: Rahul MALIK, San Diego, CA (US); Carl HARDIN, Encinitas, CA (US); Arunava CHAUDHURI, San Diego, CA (US); Yongle WU, San Diego, CA (US)

(21) Appl. No.: 19/206,683

(22) Filed: May 13, 2025

Related U.S. Application Data
(60) Provisional application No. 63/647,573, filed on May 14, 2024.

(51) Int. Cl. H04L 27/26; H04B 7/0413; H04L 5/00

(52) U.S. Cl. CPC H04L 27/26414; H04B 7/0413; H04L 5/0098

(57) ABSTRACT

Various aspects of the present disclosure generally relate to communication. In some aspects, a first device may determine a frequency division multiplexing (FDM) configuration for a set of component carriers associated with a cable frequency spectrum, wherein each component carrier in the set of component carriers is associated with a number of multiple input multiple output (MIMO) layers. The first device may communicate with a second device over a cable infrastructure according to the FDM configuration for the set of component carriers. Numerous other aspects are described.

### CROSS-REFERENCE TO RELATED APPLICATION

This patent application claims priority to U.S. Provisional Patent Application No. 63/647,573, filed on May 14, 2024, entitled “FREQUENCY CONFIGURATIONS TO COMMUNICATE OVER CABLE INFRASTRUCTURE USING RADIO ACCESS TECHNOLOGY,” and assigned to the assignee hereof. The disclosure of the prior application is considered part of and is incorporated by reference into this patent application.

### FIELD OF THE DISCLOSURE

Aspects of the present disclosure generally relate to communication and specifically relate to techniques, apparatuses, and methods associated with frequency configurations to communicate over a cable infrastructure using a radio access technology.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of communication performed by a first device. The method may include determining a frequency division multiplexing (FDM) configuration for a set of component carriers associated with a cable frequency spectrum, wherein each component carrier in the set of component carriers is associated with a number of multiple input multiple output (MIMO) layers. The method may include communicating with a second device over a cable infrastructure according to the FDM configuration for the set of component carriers.

Some aspects described herein relate to a method of communication performed by a first device. The method may include determining a frequency division duplexing (FDD) configuration for a cable frequency spectrum, wherein the FDD configuration allocates a first portion of the cable frequency spectrum to downlink communication and allocates a second portion of the cable frequency spectrum to uplink communication. The method may include communicating with a second device over a cable infrastructure according to the FDD configuration for the cable frequency spectrum.

Some aspects described herein relate to a method of communication performed by a network node. The method may include configuring time division duplexing (TDD) for a cable frequency spectrum that includes a set of component carrier layers, wherein configuring TDD for the cable frequency spectrum includes allocating respective subsets of the component carrier layers to multiple uplink user groups for uplink communication. The method may include receiving, from the multiple uplink user groups over a cable infrastructure, uplink transmissions via the respective subsets of the component carrier layers in one or more transmission time intervals (TTIs) that are configured for uplink communication.

Some aspects described herein relate to a method of communication performed by a network node. The method may include configuring multiple systems in a cable frequency spectrum, wherein the multiple systems are each allocated a respective portion of the cable frequency spectrum. The method may include communicating with a user device via a system, of the multiple systems, over a cable infrastructure.

Some aspects described herein relate to a first device for communication. The first device may include one or more memories and one or more processors coupled to the one or more memories. The one or more processors may be configured to cause the first device to determine an FDM configuration for a set of component carriers associated with a cable frequency spectrum, wherein each component carrier in the set of component carriers is associated with a number of MIMO layers. The one or more processors may be configured to cause the first device to communicate with a second device over a cable infrastructure according to the FDM configuration for the set of component carriers.

Some aspects described herein relate to a first device for communication. The first device may include one or more memories and one or more processors coupled to the one or more memories. The one or more processors may be configured to cause the first device to determine an FDD configuration for a cable frequency spectrum, wherein the FDD configuration allocates a first portion of the cable frequency spectrum to downlink communication and allocates a second portion of the cable frequency spectrum to uplink communication. The one or more processors may be configured to cause the first device to communicate with a second device over a cable infrastructure according to the FDD configuration for the cable frequency spectrum.

Some aspects described herein relate to a network node for communication. The network node may include one or more memories and one or more processors coupled to the one or more memories. The one or more processors may be configured to cause the network node to configure TDD for a cable frequency spectrum that includes a set of component carrier layers, wherein configuring TDD for the cable frequency spectrum includes allocating respective subsets of the component carrier layers to multiple uplink user groups for uplink communication. The one or more processors may be configured to cause the network node to receive, from the multiple uplink user groups over a cable infrastructure, uplink transmissions via the respective subsets of the component carrier layers in one or more TTIs that are configured for uplink communication.

Some aspects described herein relate to a network node for communication. The network node may include one or more memories and one or more processors coupled to the one or more memories. The one or more processors may be configured to cause the network node to configure multiple systems in a cable frequency spectrum, wherein the multiple systems are each allocated a respective portion of the cable frequency spectrum. The one or more processors may be configured to cause the network node to communicate with a user device via a system, of the multiple systems, over a cable infrastructure.

Some aspects described herein relate to a non-transitory computer-readable medium that stores a set of instructions for communication by a first device. The set of instructions, when executed by one or more processors of the first device, may cause the first device to determine an FDM configuration for a set of component carriers associated with a cable frequency spectrum, wherein each component carrier in the set of component carriers is associated with a number of MIMO layers. The set of instructions, when executed by one or more processors of the first device, may cause the first device to communicate with a second device over a cable infrastructure according to the FDM configuration for the set of component carriers.

Some aspects described herein relate to a non-transitory computer-readable medium that stores a set of instructions for communication by a first device. The set of instructions, when executed by one or more processors of the first device, may cause the first device to determine an FDD configuration for a cable frequency spectrum, wherein the FDD configuration allocates a first portion of the cable frequency spectrum to downlink communication and allocates a second portion of the cable frequency spectrum to uplink communication. The set of instructions, when executed by one or more processors of the first device, may cause the first device to communicate with a second device over a cable infrastructure according to the FDD configuration for the cable frequency spectrum.

Some aspects described herein relate to a non-transitory computer-readable medium that stores a set of instructions for communication by a network node. The set of instructions, when executed by one or more processors of the network node, may cause the network node to configure TDD for a cable frequency spectrum that includes a set of component carrier layers, wherein configuring TDD for the cable frequency spectrum includes allocating respective subsets of the component carrier layers to multiple uplink user groups for uplink communication. The set of instructions, when executed by one or more processors of the network node, may cause the network node to receive, from the multiple uplink user groups over a cable infrastructure, uplink transmissions via the respective subsets of the component carrier layers in one or more TTIs that are configured for uplink communication.

Some aspects described herein relate to a non-transitory computer-readable medium that stores a set of instructions for communication by a network node. The set of instructions, when executed by one or more processors of the network node, may cause the network node to configure multiple systems in a cable frequency spectrum, wherein the multiple systems are each allocated a respective portion of the cable frequency spectrum. The set of instructions, when executed by one or more processors of the network node, may cause the network node to communicate with a user device via a system, of the multiple systems, over a cable infrastructure.

Some aspects described herein relate to an apparatus for communication. The apparatus may include means for determining an FDM configuration for a set of component carriers associated with a cable frequency spectrum, wherein each component carrier in the set of component carriers is associated with a number of MIMO layers. The apparatus may include means for communicating with a second device over a cable infrastructure according to the FDM configuration for the set of component carriers.

Some aspects described herein relate to an apparatus for communication. The apparatus may include means for determining an FDD configuration for a cable frequency spectrum, wherein the FDD configuration allocates a first portion of the cable frequency spectrum to downlink communication and allocates a second portion of the cable frequency spectrum to uplink communication. The apparatus may include means for communicating with a second device over a cable infrastructure according to the FDD configuration for the cable frequency spectrum.

Some aspects described herein relate to an apparatus for communication. The apparatus may include means for configuring TDD for a cable frequency spectrum that includes a set of component carrier layers, wherein configuring TDD for the cable frequency spectrum includes allocating respective subsets of the component carrier layers to multiple uplink user groups for uplink communication. The apparatus may include means for receiving, from the multiple uplink user groups over a cable infrastructure, uplink transmissions via the respective subsets of the component carrier layers in one or more TTIs that are configured for uplink communication.

Some aspects described herein relate to an apparatus for communication. The apparatus may include means for configuring multiple systems in a cable frequency spectrum, wherein the multiple systems are each allocated a respective portion of the cable frequency spectrum. The apparatus may include means for communicating with a user device via a system, of the multiple systems, over a cable infrastructure.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating an example disaggregated base station architecture.

FIGS. 4A-4F are diagrams illustrating examples associated with frequency division multiplexing (FDM) multiple input multiple output (MIMO) configurations to communicate over a cable infrastructure using a radio access technology (RAT).

FIG. 5 is a diagram illustrating an example associated with a frequency division duplexing (FDD) configuration to communicate over a cable infrastructure using a RAT.

FIGS. 6A-6C are diagrams illustrating examples associated with time division duplexing (TDD) configurations to communicate over a cable infrastructure using a RAT.

FIGS. 7A-7B are diagrams illustrating examples associated with multi-system operations to communicate over a cable infrastructure using a RAT.

FIGS. 8-9 are flowcharts illustrating example processes performed, for example, by a UE or a network node.

FIGS. 10-11 are flowcharts illustrating example processes performed, for example, by a network node.

FIGS. 12-13 are diagrams of example apparatuses for communication over a cable infrastructure using a RAT.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) user equipment (UE) functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

For example, one potential use case for a multiple-access RAT, such as 5G NR, is to support communication using the RAT over cable to provide internet service or other communication services over a deployed cable infrastructure (e.g., as an alternative to or an improvement upon the Data Over Cable Service Interface Specification (DOCSIS) standard that permits adding high-bandwidth data transfer to an existing cable television system). However, one challenge that arises when using a RAT to communicate over a cable infrastructure is that a RAT is generally designed for wireless channels and employs multiple-input multiple-output (MIMO) to exploit spatial diversity in the wireless channels. For example, in MIMO communication, multiple signals (e.g., multiple layers or multiple data streams) are simultaneously transmitted and/or received over the same time and frequency resources to exploit multipath propagation using various spatial processing or spatial multiplexing operations. However, cable channels are single-input single-output (SISO) in nature. Accordingly, in a system that supports communication using a RAT over a cable infrastructure (which may be referred to herein as a RoC system, or an NR over cable (NRoC) system where NR is the RAT used to communicate over the cable infrastructure), techniques are needed to leverage the capabilities and envelope of wireless radios that are designed for wireless applications. Furthermore, similar challenges may arise when developing systems to use a RAT to communicate over other wired infrastructure, such as power-line communication (PLC) that carries data on a wiring infrastructure used for electric power transmission or electric power distribution.

Various aspects relate generally to frequency configurations to enable communication over a cable infrastructure using a RAT, such as 5G NR or the like. Some aspects more specifically relate to frequency division multiplexing (FDM) configurations that a transmitter may apply to MIMO layers and/or component carriers to ensure effective transmission over the cable infrastructure and/or FDM configurations that a receiver may apply to a signal received over the cable infrastructure to feed the signal back to an RF transceiver as MIMO layers. For example, some aspects described herein relate to FDM configurations that can be used to arrange various MIMO layers of a component carrier in a frequency space (e.g., within a frequency spectrum) and to exemplary hardware implementations that may support the FDM configurations using an RF transceiver or wireless radio. Furthermore, some aspects described herein relate to different duplexing schemes, such as time division duplexing (TDD) and/or frequency division duplexing (FDD), that may be used in combination with the FDM configurations to improve usage of cable frequency spectrum for uplink and/or downlink communication. Furthermore, some aspects described herein relate to multi-system operation over cable infrastructure, where multiple systems (e.g., similar to cells in a wireless network) may be deployed in a cable frequency spectrum to support efficient load balancing, handover, and/or mobility functions according to pathloss characteristics associated with the cable infrastructure. Furthermore, although some aspects described herein relate to supporting a RAT over a cable infrastructure, similar techniques may be applied for other wired infrastructures, such as using electric power lines to support power-line communication using a RAT.

Particular aspects of the subject matter described in this disclosure can be implemented to realize one or more of the following potential advantages. In some examples, by defining FDM configurations for arranging MIMO layers of a component carrier in frequency space within a cable frequency spectrum, a wireless radio may be configured to support effective transmission and reception over a cable infrastructure. Furthermore, configuring an FDD scheme may enable simultaneous downlink and uplink communication and/or may improve uplink performance (e.g., in consideration of mobile or wireless chipsets often being uplink-limited), and configuring a multi-user TDD scheme may increase utilization and/or spectral efficiency during uplink phases of a duty cycle in a TDD deployment. Furthermore, supporting multi-system operation may maximize spectrum utilization and/or may improve performance by using mobility procedures and/or load balancing functions to schedule users on component carriers or component carrier layers in a manner that exploits pathloss characteristics of the cable.

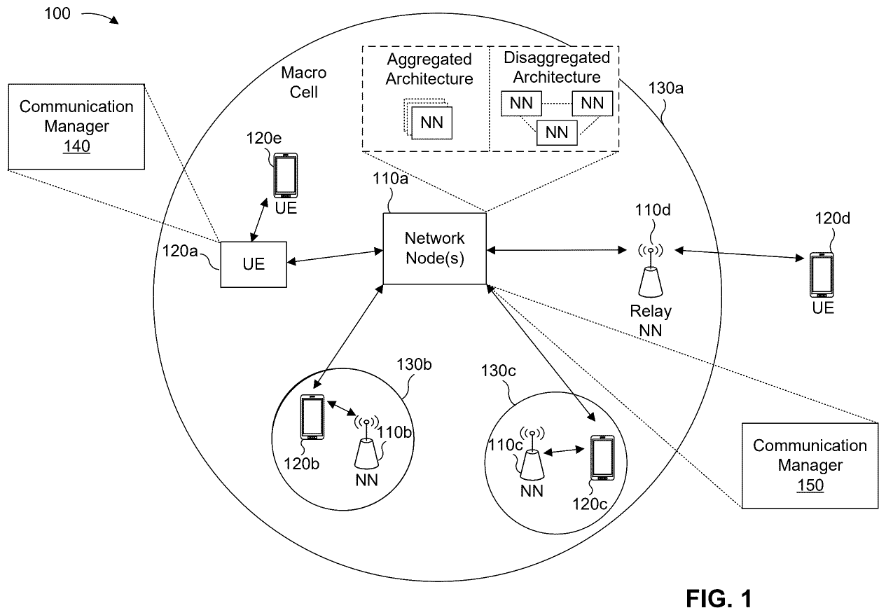

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve TDD, in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve FDD, in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. For example, as described herein, MIMO communication generally includes transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may determine an FDM configuration for a set of component carriers associated with a cable frequency spectrum, wherein each component carrier in the set of component carriers is associated with a number of MIMO layers; and communicate with a second device over a cable infrastructure according to the FDM configuration for the set of component carriers. Additionally, or alternatively, the communication manager 140 may determine an FDD configuration for a cable frequency spectrum, wherein the FDD configuration allocates a first portion of the cable frequency spectrum to downlink communication and allocates a second portion of the cable frequency spectrum to uplink communication; and communicate with a second device over a cable infrastructure according to the FDD configuration for the cable frequency spectrum. Additionally, or alternatively, the communication manager 140 may perform one or more other operations described herein.

In some aspects, the network node 110 include a communication manager 150. As described in more detail elsewhere herein, the communication manager 150 may determine an FDM configuration for a set of component carriers associated with a cable frequency spectrum, wherein each component carrier in the set of component carriers is associated with a number of MIMO layers; and communicate with a second device over a cable infrastructure according to the FDM configuration for the set of component carriers. Additionally, or alternatively, the communication manager 150 may determine an FDD configuration for a cable frequency spectrum, wherein the FDD configuration allocates a first portion of the cable frequency spectrum to downlink communication and allocates a second portion of the cable frequency spectrum to uplink communication; and communicate with a second device over a cable infrastructure according to the FDD configuration for the cable frequency spectrum. Additionally, or alternatively, the communication manager 140 may configure TDD for a cable frequency spectrum that includes a set of component carrier layers, wherein configuring TDD for the cable frequency spectrum includes allocating respective subsets of the component carrier layers to multiple uplink user groups for uplink communication; and receiving, from the multiple uplink user groups over a cable infrastructure, uplink transmissions via the respective subsets of the component carrier layers in one or more transmission time intervals (TTIs) that are configured for uplink communication. Additionally, or alternatively, the communication manager 150 configure multiple systems in a cable frequency spectrum, wherein the multiple systems are each allocated a respective portion of the cable frequency spectrum; and communicate with a user device via a system, of the multiple systems, over a cable infrastructure. Additionally, or alternatively, the communication manager 150 may perform one or more other operations described herein.

As indicated above, FIG. 1 is provided as an example. Other examples may differ from what is described with regard to FIG. 1.

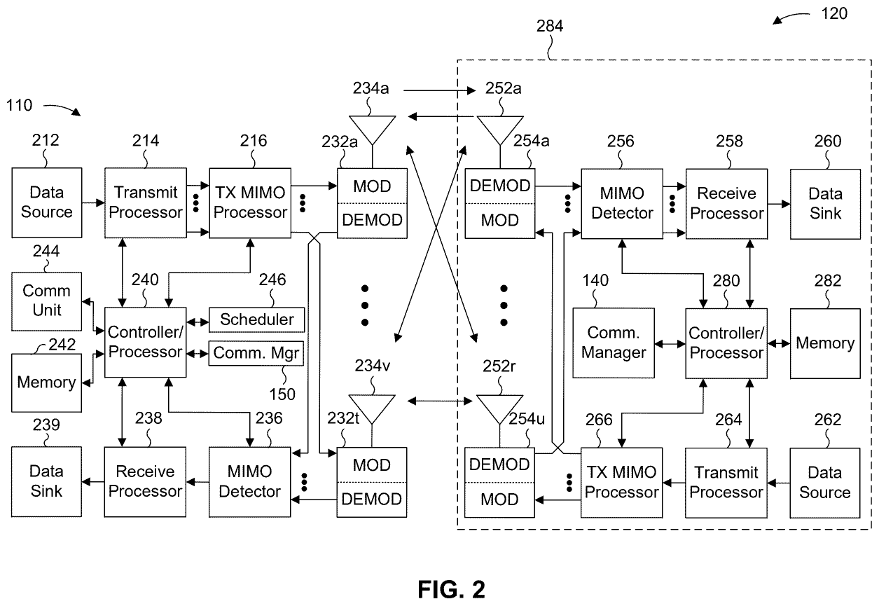

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

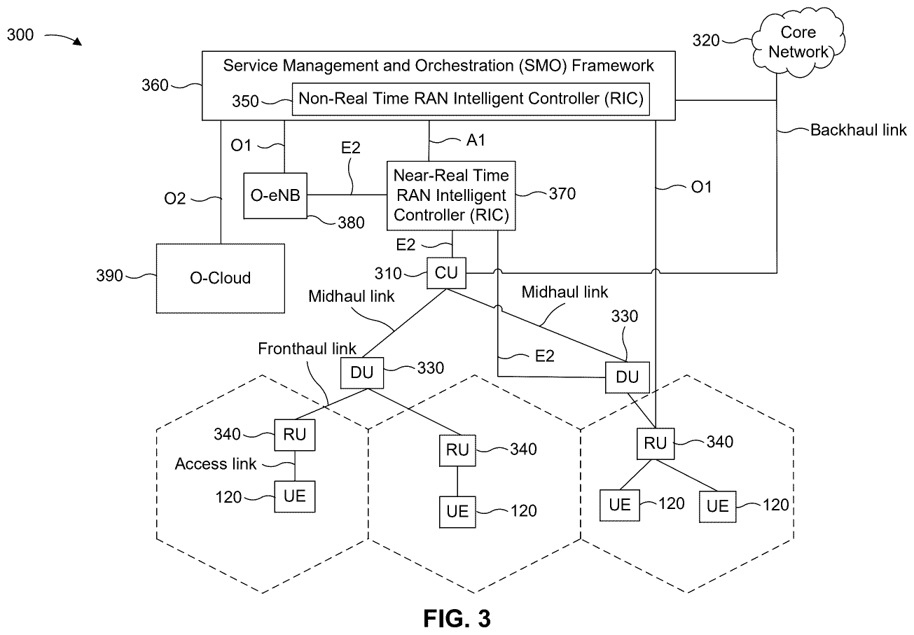

FIG. 3 is a diagram illustrating an example disaggregated base station architecture 300. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

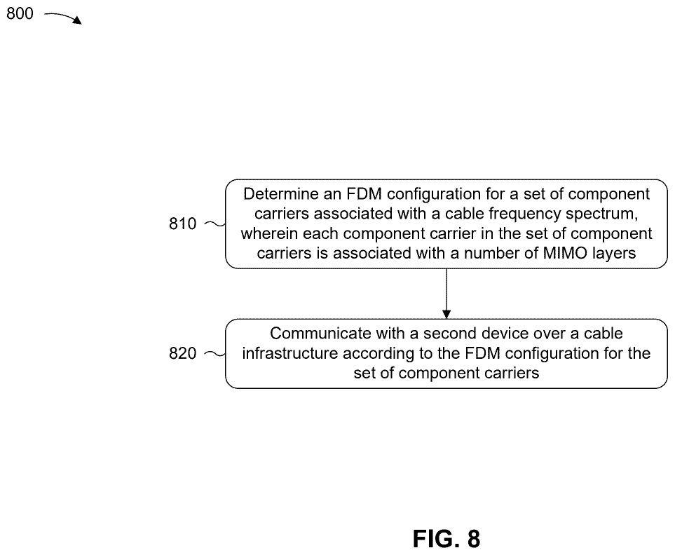

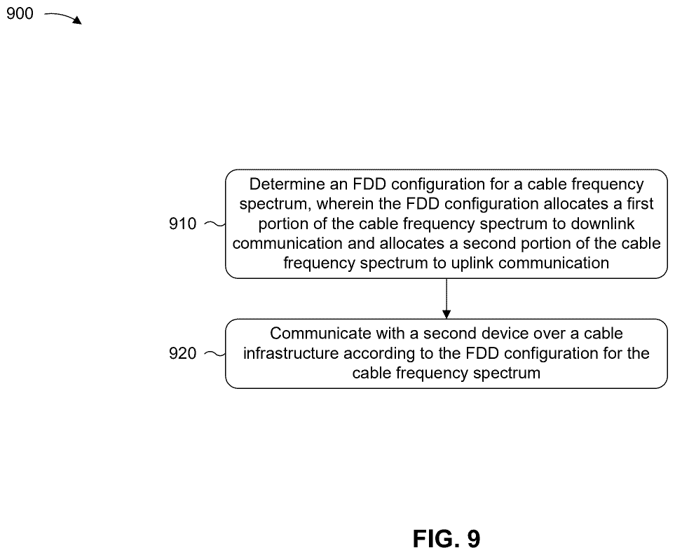

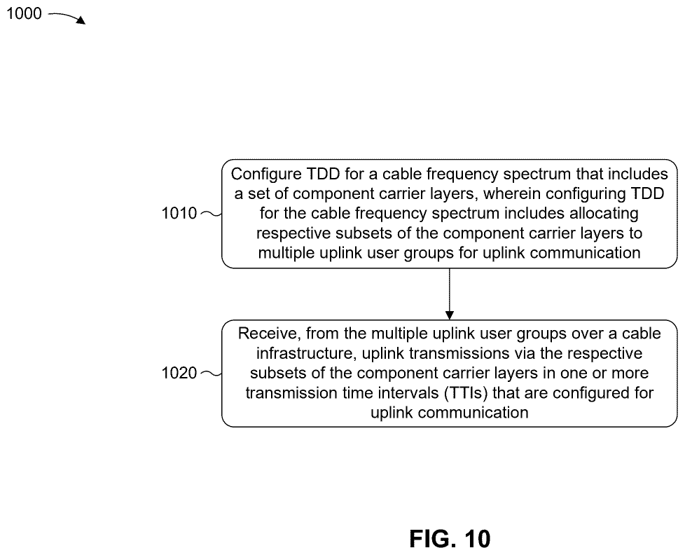

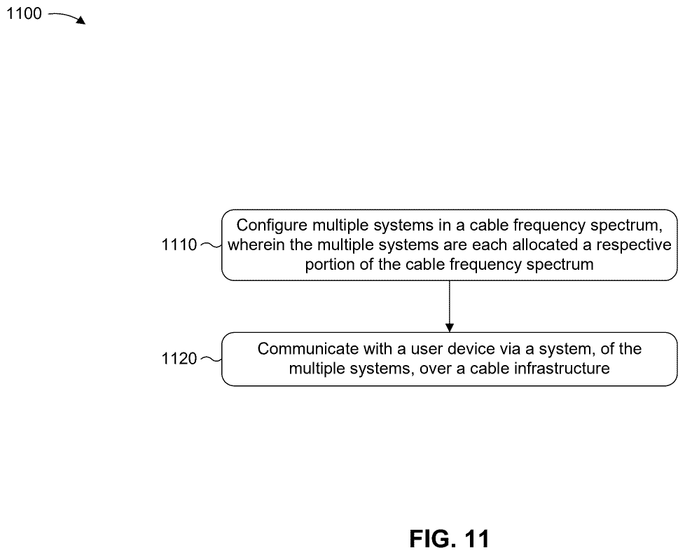

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with frequency configurations to communicate over a cable infrastructure using a RAT, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for determining an FDM configuration for a set of component carriers associated with a cable frequency spectrum, wherein each component carrier in the set of component carriers is associated with a number of MIMO layers; and/or means for communicating with a second device over a cable infrastructure according to the FDM configuration for the set of component carriers.

In some aspects, the UE 120 includes means for determining an FDD configuration for a cable frequency spectrum, wherein the FDD configuration allocates a first portion of the cable frequency spectrum to downlink communication and allocates a second portion of the cable frequency spectrum to uplink communication; and/or means for communicating with a second device over a cable infrastructure according to the FDD configuration for the cable frequency spectrum.

In some aspects, the means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for determining an FDM configuration for a set of component carriers associated with a cable frequency spectrum, wherein each component carrier in the set of component carriers is associated with a number of MIMO layers; and/or means for communicating with a second device over a cable infrastructure according to the FDM configuration for the set of component carriers.

In some aspects, the network node 110 includes means for determining an FDD configuration for a cable frequency spectrum, wherein the FDD configuration allocates a first portion of the cable frequency spectrum to downlink communication and allocates a second portion of the cable frequency spectrum to uplink communication; and/or means for communicating with a second device over a cable infrastructure according to the FDD configuration for the cable frequency spectrum.

In some aspects, the network node 110 includes configuring TDD for a cable frequency spectrum that includes a set of component carrier layers, wherein configuring TDD for the cable frequency spectrum includes allocating respective subsets of the component carrier layers to multiple uplink user groups for uplink communication; and/or receiving, from the multiple uplink user groups over a cable infrastructure, uplink transmissions via the respective subsets of the component carrier layers in one or more TTIs that are configured for uplink communication.

In some aspects, the network node 110 includes means for configuring multiple systems in a cable frequency spectrum, wherein the multiple systems are each allocated a respective portion of the cable frequency spectrum; and/or means for communicating with a user device via a system, of the multiple systems, over a cable infrastructure.

In some aspects, the means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

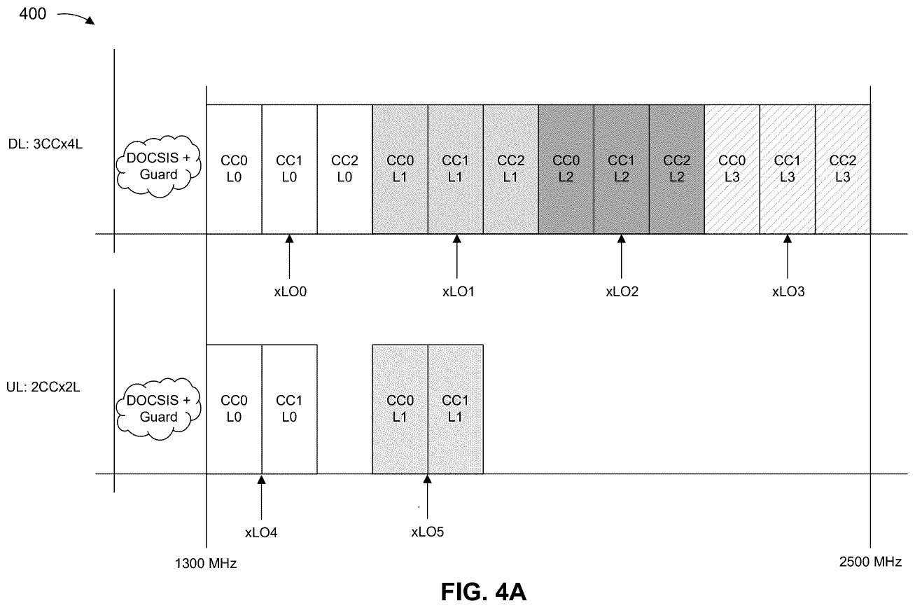

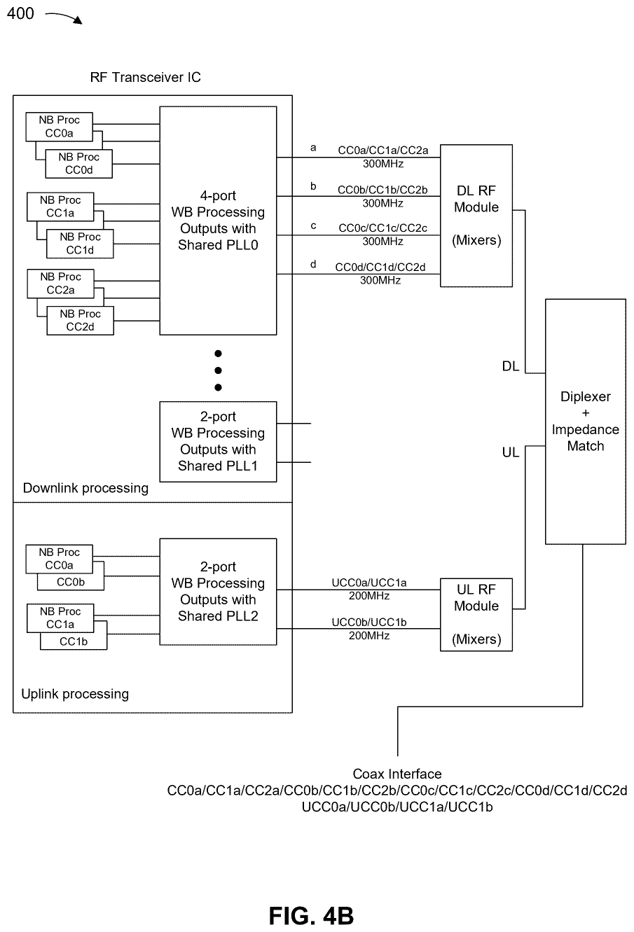

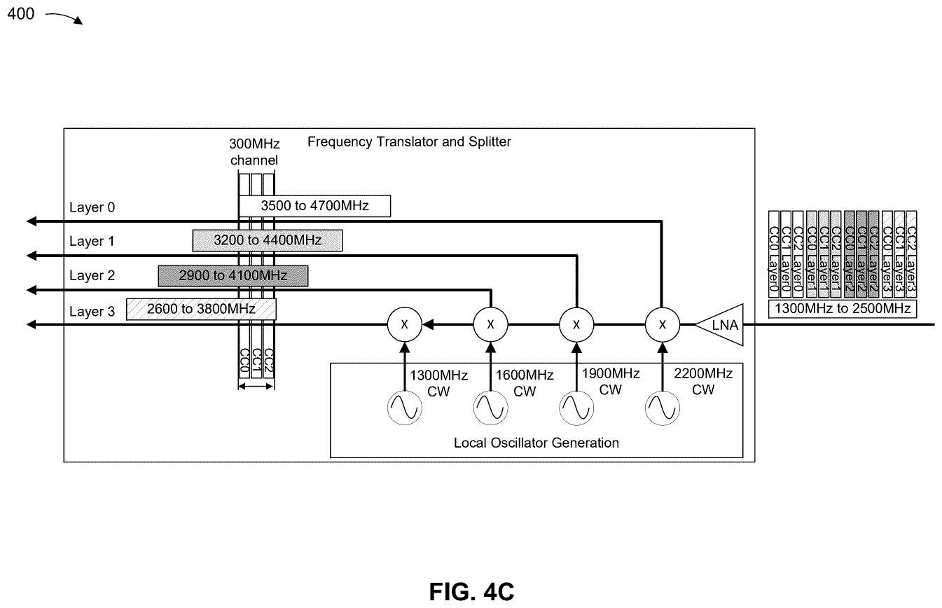

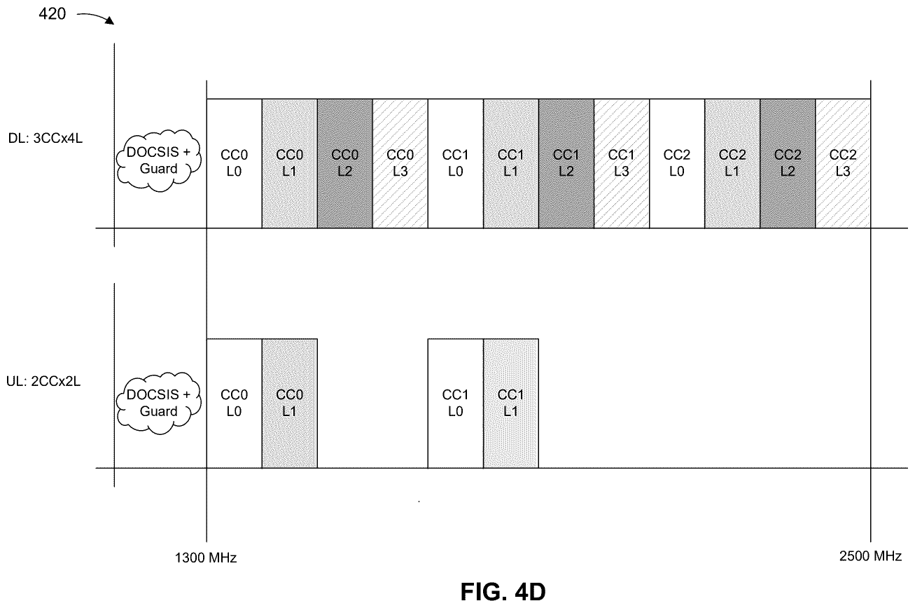

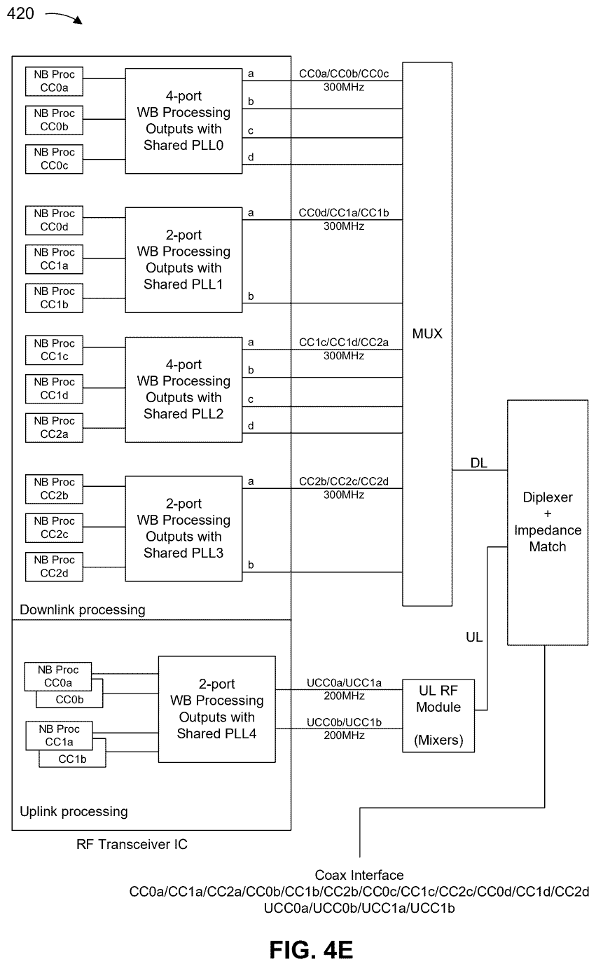

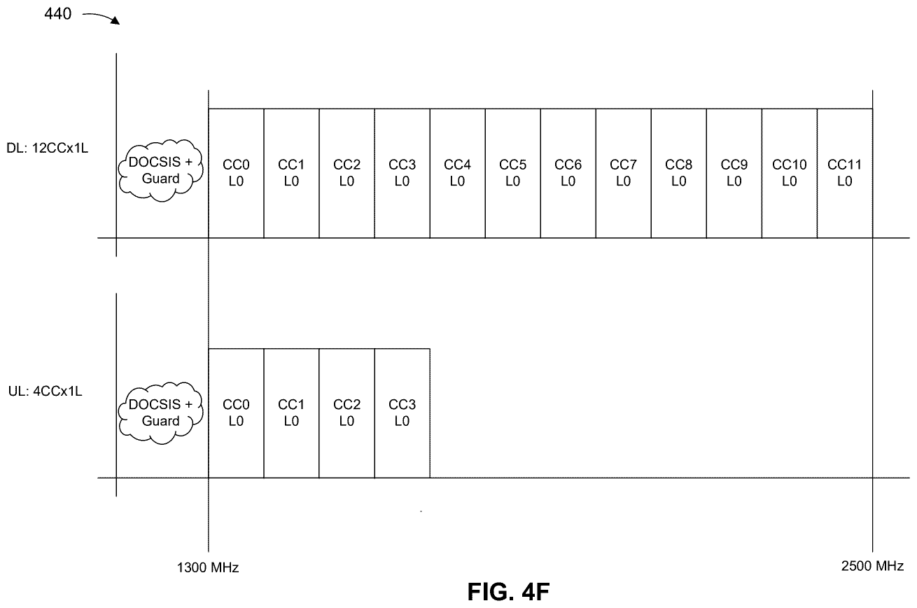

FIGS. 4A-4F are diagrams illustrating examples 400, 420, and 440 associated with FDM MIMO configurations to communicate over a cable infrastructure using a RAT. For example, as described herein, the FDM MIMO configurations may each arrange various MIMO layers of a component carrier in a frequency space (e.g., a frequency spectrum or a portion of a frequency spectrum) in a manner that leverages the capabilities and envelope of a wireless radio to enable effective transmission over a cable infrastructure and/or to feed a received signal associated with the FDM configuration as MIMO layers to a receiving component in an RF transceiver or wireless radio. In some aspects, as described herein, the FDM configurations may generally be used for downlink communication, where a network node or head-end may use the FDM configurations to transmit a downlink signal to a UE or customer premises equipment (CPE) over a cable infrastructure, and for uplink communication, where a UE or CPE may use the FDM configurations to transmit an uplink signal to a network node or head-end over the cable infrastructure.

In some aspects, as described herein, the FDM configurations shown by examples 400, 420, and 440 may generally be used to arrange various MIMO layers of a component carrier in a frequency space. For example, as described herein, a component carrier may be mapped to one or more MIMO layers (e.g., transmission streams), where each MIMO layer may be referred to herein as a component carrier layer (CCL). For example, in an RoC, NRoC, or other system that uses a RAT to enable communication over a cable infrastructure, communication may be enabled using multiple component carriers, where the notation CCxLy may be used to refer to component carrier #x and MIMO layer #y with reference to a modem supporting the RoC or NRoC system. As described in further detail herein, the FDM configurations shown by examples 400, 420, and 440 may each define a CCL placement within a frequency spectrum, where each CCL placement may offer different tradeoffs with respect to ease of implementation (e.g., with existing wireless radio designs or potential advances in wireless radio technology) versus performance and/or operational benefits. Furthermore, in some cases, different devices (e.g., network devices such as a network node, network elements such as amplifiers, splitters, and/or taps, and/or user devices such as UEs and/or CPEs) may have different capabilities and may support (or lack support for) one or more of the FDM configurations described herein. Accordingly, as described herein, devices that communicate over the cable infrastructure using one or more of the FDM configurations described herein may exchange signaling to coordinate negotiation of the FDM configuration to be used and/or to ensure interoperability between network devices, network elements, and/or user devices supporting the FDM configurations. For example, in some aspects, a network node and a UE/CPE may exchange capability signaling (e.g., online or offline via a preconfiguration or out-of-band signaling) to coordinate the FDM configuration to be used according to a protocol that may define band and/or carrier aggregation combinations to indicate the CCL placement and/or duplexing scheme, UE capabilities to specify carrier bandwidth, subcarrier spacing, and/or MCS capabilities for using a RAT to communicate over cable infrastructure, RRC configurations (e.g., the number, pattern, and/or placement of a DMRS when using a RAT to communicate over cable infrastructure, and/or one or more system information blocks (SIBs) or extensions to existing SIBs, such as SIB1).

In some aspects, as described herein, the FDM configurations shown by examples 400, 420, and 440 may each define an arrangement for a set of CCLs within a frequency space or frequency region associated with a cable frequency spectrum. For example, to ensure coexistence with DOCSIS (e.g., DOCSIS 3.1 and later versions), which occupies frequency spectrum from about 5 MHz to about 1200 MHZ, the FDM configurations may start at a frequency of 1300 MHz or higher, with a guard band from about 1200 MHz to about 1300 MHz. For example, FIG. 4A, FIG. 4D, and FIG. 4F illustrate example FDM configurations that start at 1300 MHz and stop at 2500 MHz for RoC or NRoC deployments that include 12 CCLs that each have a 100 MHz bandwidth. However, the starting frequency and the ending frequency of the CCLs provided herein are examples only, and an RoC or NRoC deployment may occupy a different portion of the cable frequency spectrum. Furthermore, some aspects are described herein with a 100 MHz channel bandwidth to enable reusing NR techniques or other established RAT techniques and to maximize an envelope of existing wireless chipsets. Furthermore, although some aspects are described herein with respect to frequencies in FR1, similar techniques may be applied in other frequencies, such as FR2. Furthermore, other suitable channelizations (e.g., channel bandwidths other than 100 MHz may be used), and each FDM configuration described herein may implement TDD for uplink and downlink communication (e.g., using each CCL for uplink communication only or downlink communication only in a given TTI) or using FDD for uplink and downlink communication (e.g., using a first set of frequencies or CCLs for uplink communication and a second set of frequencies or CCLs for downlink communication, which may enable simultaneous uplink and downlink communication, or full-duplex communication, in a cable infrastructure that is not spectrum constrained).

In some aspects, as described herein, a wireless radio or wireless chipset that supports communication over a cable infrastructure may generally have various minimum capabilities. For example, in some aspects, the FDM configurations described herein may be used by a device (e.g., a UE/CPE or network node) with wireless communication hardware that supports at least 4 layers on a downlink, at least 2 layers on an uplink, one or more 4-port wideband processing units, one or more 2-port wideband processing units, and support for a maximum bandwidth of at least 300 MHZ on a single port of a wideband processing unit. However, these capabilities are exemplary, and wireless communication hardware may have more limited capabilities or greater capabilities (e.g., support for 8 downlink layers and 4 uplink layers, and an 8-port wideband processing unit with a 400 MHz bandwidth on a single port). Furthermore, in some cases, an FDM configuration may use mixers that are external to an RF transceiver for uplink and downlink communication (e.g., as shown in FIG. 4B), or an FDM configuration use operations that are internal to the RF transceiver for downlink communication and use a mixer external to the RF transceiver for uplink communication (e.g., as shown in FIG. 4E). Accordingly, while FIGS. 4A-4F provide example FDM configurations and hardware implementations to achieve a frequency positioning for various CCLs, other suitable hardware implementations may be used and the specific choice of FDM configuration to be used may depend on the FDM configuration(s) supported by a UE/CPE and/or a network node and other factors. Furthermore, techniques for using a RAT to communicate over a cable infrastructure (e.g., as defined in one or more specifications or standards, protocols, and/or procedures) may be generic in supporting any or all of the FDM configurations.

For example, referring to FIG. 4A, example 400 illustrates a first FDM configuration in which various MIMO layers are spaced uniformly within the cable frequency spectrum (e.g., using external oscillators, as shown in FIG. 4C and described in more detail elsewhere herein). For example, FIG. 4A illustrates a frequency arrangement for downlink communication that uses three component carriers across four downlink layers, where three component carriers (CC0-CC2) each include four MIMO layers (L0-L3). Accordingly, for downlink communication, CCLs that are associated with the same MIMO layer are contiguous or adjacent within the frequency spectrum such that the MIMO layers are uniformly spaced in frequency. For example, the first three CCLs correspond to the first MIMO layer for the various component carriers (CC0L0, CC1L0, CC2L0), the next three CCLs correspond to the second MIMO layer for the various component carriers (CC0L1, CC1L1, CC2L1), and so on. As described herein, the first FDM configuration shown in FIG. 4A may be amenable to using external local oscillators to space the MIMO layers uniformly, and aims to make RoC or NRoC operation transparent to the wireless radio or wireless chipset (e.g., to reuse existing wireless radios or wireless chipsets for communication over cable infrastructure). For example, as shown in FIG. 4A, a first local oscillator (xLO0) may be configured to receive a signal at a center frequency associated with a first MIMO layer (L0), a second local oscillator (xLO1) may be configured to receive a signal at a center frequency associated with a second MIMO layer (L1), and so on. Furthermore, a similar FDM configuration may be used for uplink communication. For example, FIG. 4A illustrates an uplink configuration with two component carriers and one layer, where the two CCLs corresponding to the first (only) layer are aligned with the first two downlink CCLs. In general, the FDM configuration shown in FIG. 4A may have more external translations than the FDM configurations shown in FIGS. 4D-4F, but may be relatively easier to implement by reusing existing wireless radios or wireless chipsets.

In some aspects, as shown in FIG. 4B, an example hardware implementation for the FDM configuration shown in FIG. 4A may include an RF transceiver integrated circuit that includes a downlink processing unit coupled to a downlink external RF module and an uplink processing unit coupled to an uplink external RF module. In some aspects, the downlink external RF module may include one or more mixers for processing a received downlink signal to provide a corresponding set of signals to the downlink processing unit, and the uplink external RF module may include one or more mixers for generating an uplink signal based on a set of signals received from the uplink processing unit. For example, as shown, the downlink processing unit may include various narrowband processing units that are each configured to process a received signal associated with a respective CCL, and the various signals associated with the CCLs may be provided to the narrowband processing units via a 4-port wideband processing unit that generates a set of outputs with a shared phase-locked loop (PLL). For example, a first port (shown as line a) carries three CCLs (CC0a, CC1a, CC2a) that each have a bandwidth of 100 MHz for an aggregated bandwidth of 300 MHz and are all associated with the same layer (e.g., CC0L0-CC2L0). Similarly, a second port (shown as line b) carries three CCLs associated with a second layer, a third port (shown as line c) carries three CCLs associated with a third layer, and a fourth port (shown as line d) carries three CCLs associated with a fourth layer. The various CCLs are processed using the DL external RF module, which uses external oscillators to space the MIMO layers uniformly in the frequency space. For example, FIG. 4C illustrates an example frequency translator and splitter that may be included in the DL external RF module, where the frequency translator and splitter includes a low noise amplifier (LNA) and four local oscillators to space four MIMO layers uniformly in a frequency space. As shown in FIG. 4B, the downlink signal may be received via a coaxial cable interface, and then passed to a diplexer and impedance match component, which provides the downlink signal to the DL external RF module. The downlink signal is provided to the frequency translator and splitter shown in FIG. 4C, starting at the LNA, and the DL external RF module provides the various CCLs to the 4-port wideband processing unit. Furthermore, as shown in FIG. 4B, a similar (reverse) approach may be used for uplink communications, where uplink signals generated by narrowband processing units may be provided to the 2-port wideband processing unit, which provides the various CCLs to the UL external RF module. The uplink CCLs are then provided to the diplexer and impedance match component, which transmits the uplink CCLs via the coaxial cable interface. In some aspects, as described herein, the downlink and uplink external RF components (or a subset thereof) may be shared or separate.

Additionally, or alternatively, referring to FIG. 4D, example 420 illustrates a second FDM configuration in which various MIMO layers associated with the same component carrier are arranged contiguously (adjacent) within the cable frequency spectrum. For example, FIG. 4D illustrates a frequency arrangement for downlink communication that uses three component carriers across four downlink layers, where the four MIMO layers of the first component carrier (CC0L0-CC0L3), the four MIMO layers of the second component carrier (CC1L0-CC1L3), and the four MIMO layers of the third component carrier (CC2L0-CC2L3) are contiguous within the cable frequency spectrum. Similarly, FIG. 4D illustrates a frequency arrangement for uplink communication that uses two component carriers across two uplink layers, where the two MIMO layers of the first component carrier (CC0L0-CC0L1) and the two MIMO layers of the second component carrier (CC1L0-CC1L1) are all contiguous within the cable frequency spectrum. In this way, one or more component carriers can be enabled or disabled while maintaining a contiguous frequency allocation within the cable frequency spectrum. Accordingly, the second FDM configuration shown in FIG. 4D may allow different bandwidth modes of inline amplifiers to be used for communication over the cable infrastructure and may enable capabilities to be scaled up (e.g., to higher spectrum) as newer generations of equipment are developed (e.g., including network nodes, amplifiers, CPEs, or the like). Furthermore, because all MIMO layers associated with a single component carrier are adjacent in the cable frequency spectrum, the MIMO layers associated with a component carrier experience similar pathloss characteristics. In this way, on a shared cable drop (e.g., where a single cable drop is shared by various CPEs in different locations, such as different homes or buildings), a network node can schedule UEs/CPEs that are closer to the network node on component carriers in a higher region of the cable frequency spectrum and UEs/CPEs that are farther from the network node on component carriers in a lower region of the cable frequency spectrum (e.g., based on cable attenuation increasing with frequency). Furthermore, depending on a hardware implementation, the second FDM configuration may have fewer frequency translations relative to the hardware implementation shown in FIGS. 4B-4C for the first FDM configuration shown in FIG. 4A.

In some aspects, as shown in FIG. 4E, an example hardware implementation for the FDM configuration shown in FIG. 4D may include an RF transceiver integrated circuit that includes an uplink processing unit coupled to an uplink external RF module, and internal multiplexing capabilities of the RF transceiver may be used to enable different MIMO layers of a component carrier to be FDMed adjacent to one another (e.g., via a modem, narrowband processing, or transceiver). For example, FIG. 4E illustrates an example hardware implementation that uses internal circuitry (e.g., multiple PLLs) within the downlink processing unit of the RF transceiver to eliminate the need for an external mixer for downlink communication. For example, based on signals received from various narrowband processing units, a first 4-port wideband processing unit with a first shared PLL (PLL0) may generate the first three MIMO layers of a first component carrier, a first 2-port wideband processing unit with a second shared PLL (PLL1) may generate the fourth MIMO layer of the first component carrier and the first two MIMO layers of a second component carrier, a second 4-port wideband processing unit with a third shared PLL (PLL2) may generate the third and fourth MIMO layers of the second component carrier and the first MIMO layer of the third component carrier, and a second 2-port wideband processing unit with a fourth shared PLL (PLL3) may generate the last three MIMO layers of the third component carrier. On an uplink path, an external mixer may be used in the uplink external RF module to FDM multiplex the uplink signal as an example, but the techniques shown for using the internal multiplexing capabilities of the RF transceiver may be applied to the uplink path, the downlink path, or both the uplink and the downlink path depending on device capabilities.

Additionally, or alternatively, referring to FIG. 4F, example 440 illustrates a third FDM configuration in which the cable frequency spectrum is treated as an amalgamation of 1-layer component carriers. For example, FIG. 4F illustrates a frequency arrangement for downlink communication that uses twelve component carriers across one downlink layer, and a frequency arrangement for uplink communication that uses four component carriers across one uplink layer. The third FDM configuration shown by example 440 may be simpler than the FDM configurations shown by examples 400 and 420, but may be dependent on hardware and/or software capabilities to work on both a network node and a UE/CPE. For example, the third FDM configuration that treats the cable frequency spectrum as an amalgamation of 1-layer component carriers may depend on support for a large number of component carriers (e.g., defining encoding and/or decoding requirements, because codeblocks are restricted to a component carrier) and may depend on suitably handling a state per component carrier (e.g., frequency tracking, time tracking, or the like, which may impose software, memory, and/or hardware constraints on existing wireless radios or wireless chipsets). However, the third FDM configuration shown by example 440 may require the fewest (potentially no) external translations. In addition, from a hardware cost perspective, the second FDM configuration shown by example 420 and the third FDM configuration shown by example 440 may have a similar cost to each other, and a lower cost than the FDM configuration shown by example 400. In addition, the third FDM configuration shown by example 440 may enable optimal scheduling in the frequency domain (e.g., with reference to characteristics of the cable frequency spectrum or cable infrastructure, because individual CCLs can be activated or deactivated at a higher granularity). Furthermore, the hardware implementation shown in FIG. 4E may support the FDM configuration where each component carrier is associated with one MIMO layer, where the various single-layer component carriers may be FDMed by the modem, the narrowband/wideband processing units, and/or other components of the RF transceiver.

As indicated above, FIGS. 4A-4F are provided as an example. Other examples may differ from what is described with regard to FIGS. 4A-4F.

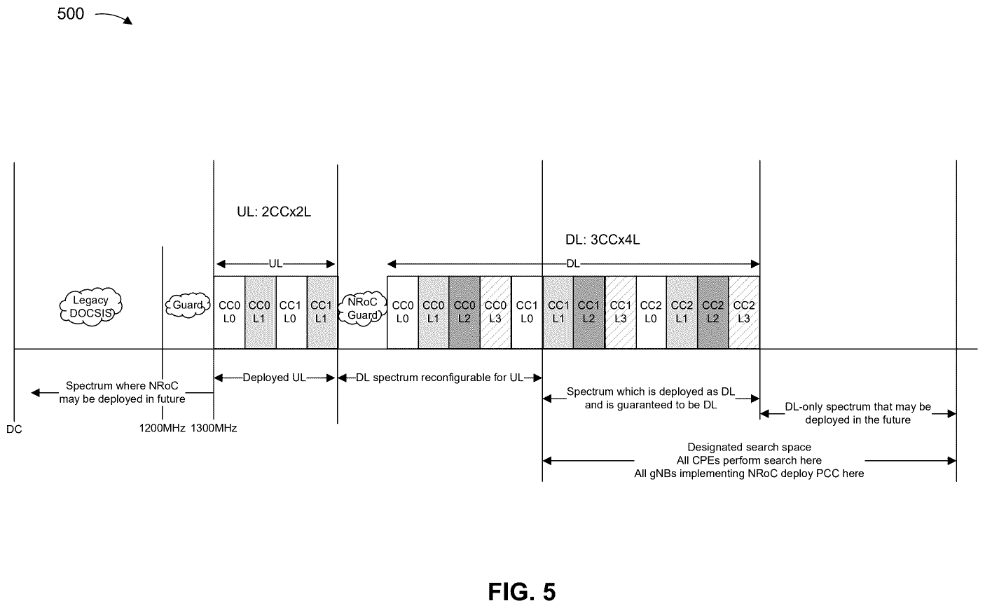

FIG. 5 is a diagram illustrating an example 500 associated with an FDD configuration to communicate over a cable infrastructure using a RAT. For example, as described herein, a set of CCLs that are used for downlink and uplink communication over a cable infrastructure may generally be deployed in an FDM configuration, where all CCLs that are associated with the same MIMO layer are contiguous or adjacent in frequency, all CCLs that are associated with the same component carrier are contiguous or adjacent in frequency, or all component carriers are associated with one layer.

Furthermore, as described herein, the CCLs may be deployed in a TDD configuration or an FDD configuration. For example, in a TDD configuration, each CCL is either used for uplink communication or for downlink communication in a particular TTI (e.g., according to a TDD configuration pattern that defines uplink TTIs, downlink TTIs, and/or flexible TTIs that can be configured for uplink, downlink, and/or sub-band full-duplexing). In some aspects, to support a TDD configuration, one or more band combinations within the cable frequency spectrum and/or appropriate UE capabilities may be defined (e.g., to specify frequency bands or frequency regions within the cable frequency spectrum that are deployed in the TDD mode and to specify UE capabilities and/or parameters for communicating in the TDD mode).

Additionally, or alternatively, one or more frequency bands or frequency regions (e.g., sets of frequencies) in the cable frequency spectrum may be deployed in an FDD mode (e.g., to improve uplink performance, particularly in view of wireless chipsets typically being uplink-limited). For example, in an FDD mode, one or more frequency regions or sets of frequencies may be configured for downlink communication, and one or more frequency regions or sets of frequencies may be configured for uplink communication. In this way, a UE or CPE may transmit uplink data in the uplink frequency region(s) and simultaneously receive downlink data in the downlink frequency region(s). In some aspects, to support an FDD configuration, one or more band combinations within the cable frequency spectrum and/or appropriate UE capabilities may be defined (e.g., to specify frequency bands or frequency regions within the cable frequency spectrum that are deployed in the FDD mode and to specify UE capabilities and/or parameters for communicating in the FDD mode). For example, FIG. 5 illustrates an example FDD deployment where a first frequency region is deployed in an uplink mode, with 4 CCLs (e.g., 2 uplink component carriers across 2 MIMO layers), and a second frequency region is deployed in a downlink mode, with 12 CCLs (e.g., 3 downlink component carriers across 4 MIMO layers). Furthermore, as shown in FIG. 5, a guard band may be provided between the uplink frequency region and the downlink frequency region to mitigate interference.

In some aspects, as described herein, the overall cable frequency spectrum that is available for RoC or NRoC deployments may support TDD and FDD deployments (e.g., in different frequency regions, similar to frequency bands that are designated to be used in a TDD mode or an FDD mode for wireless communication). Accordingly, because the cable frequency spectrum may support TDD and FDD deployments and/or may be configurable or reconfigurable in a TDD mode or an FDD mode, the cable frequency spectrum may include one or more dedicated or designated frequency regions that are guaranteed or reserved to always being deployed for downlink communication, regardless of whether the RoC or NRoC system is deployed in an FDD mode, a TDD mode, or a combination thereof. For example, in some aspects, the frequency regions that are guaranteed or reserved to always being deployed for downlink communication may be defined according to one or more band combinations, and may correspond to a frequency region that contains a default UE search space and a frequency region that supports camping by UEs and/or CPEs based on decoding broadcast information (e.g., a master information block (MIB) and/or one or more SIBs) and determining cell capabilities. Furthermore, because uplink communication may have better performance at lower frequencies, the downlink-only frequency region that contains the default UE search space may be located in an upper region of the downlink-only spectrum. For example, in the FDD deployment shown in FIG. 5, CC0L0 through CC1L0 are allocated in a portion of the cable frequency spectrum that is deployed as downlink and reconfigurable in an uplink mode, and CC1L1 through CC2L3 are allocated in a portion of the cable frequency spectrum that is deployed as downlink and not reconfigurable in an uplink mode (e.g., guaranteed to always be downlink). In addition, there may be unused higher frequencies or higher frequency regions that are designated downlink-only. Accordingly, the default UE search space may be contained within the downlink-only frequency regions to ensure that any changes to the uplink or downlink deployments do not impact the location of the default UE search space. Furthermore, as shown in FIG. 5, any network nodes that implement an RoC or NRoC system may deploy a primary component carrier (PCC) within the downlink-only frequency regions. Furthermore, as shown in FIG. 5, the downlink-only frequency regions are located at higher frequencies than the downlink frequency region that is reconfigurable as uplink.

As indicated above, FIG. 5 is provided as an example. Other examples may differ from what is described with regard to FIG. 5.

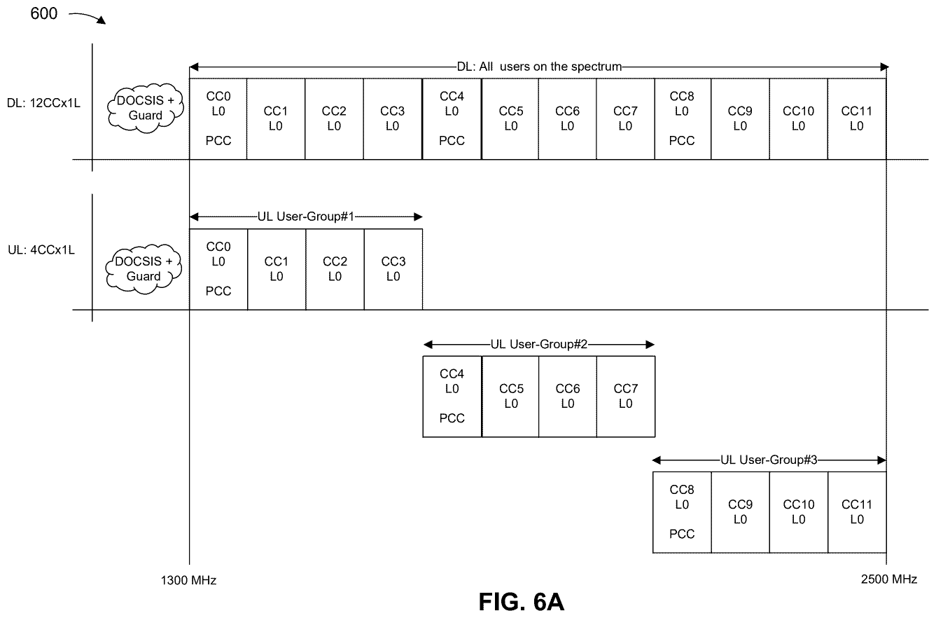

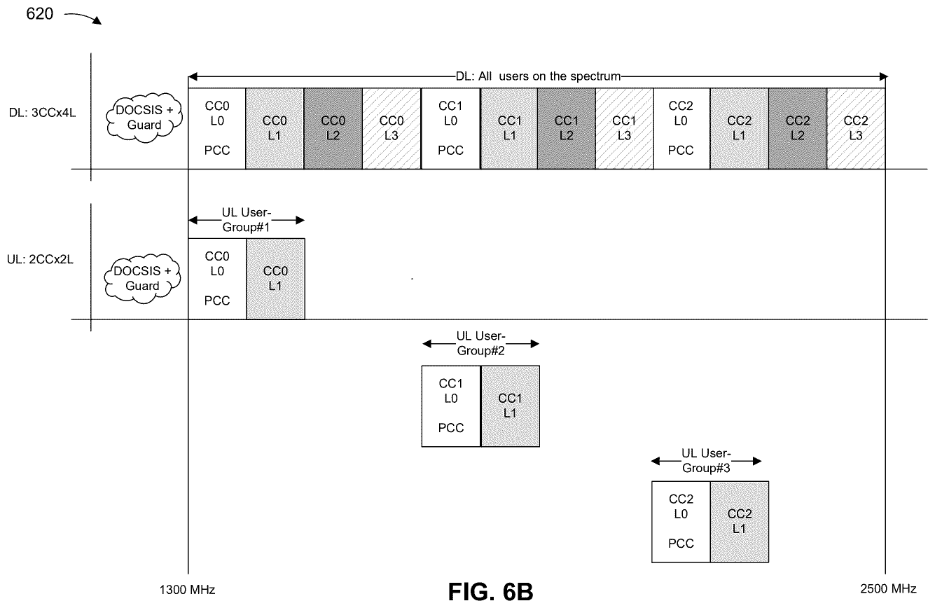

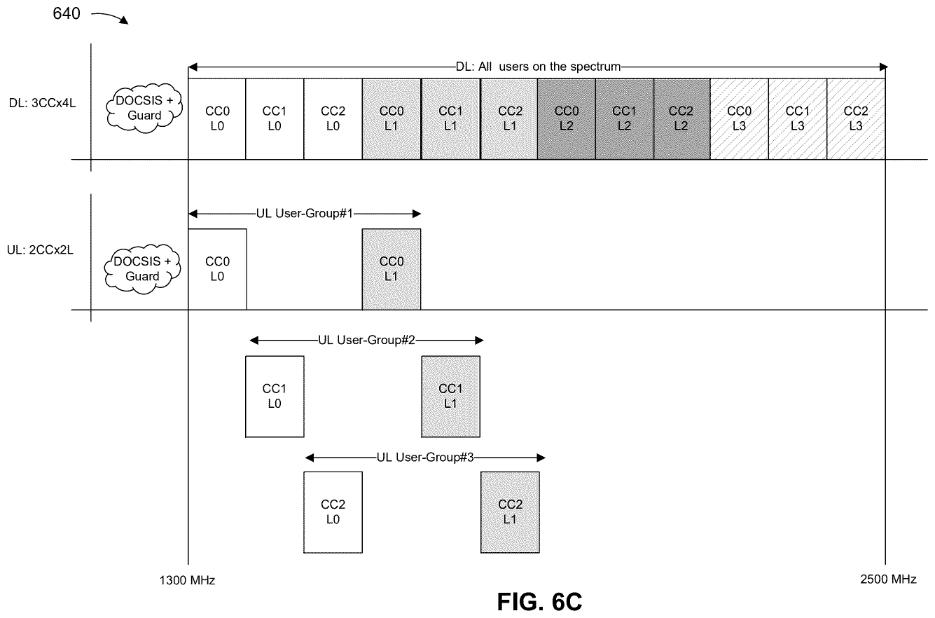

FIGS. 6A-6C are diagrams illustrating examples 600, 620, and 640 associated with TDD configurations to communicate over a cable infrastructure using a RAT. As described herein, an RoC or NRoC system may be deployed using wireless radios, wireless chipsets, RF transceivers, and/or other hardware, software, and/or protocol-based techniques that are designed for wireless communication. Accordingly, one challenge that may arise in an RoC or NRoC system is that the resources used for wireless communication tend to be constrained in an uplink envelope relative to a downlink envelope, particular at a UE. For example, some wireless chipsets may support 3 component carriers across 4 MIMO layers on a downlink, but only 2 component carriers across 2 MIMO layers on an uplink. As a result, in a TDD deployment where frequency resources are used for uplink communication and downlink communication in different TTIs, the frequency spectrum deployed in a TDD mode may be underutilized during an uplink phase of the duty cycle. Accordingly, in some aspects, utilization of frequency spectrum deployed in a TDD mode may be increased by appropriate network configurations, with varying improvements to the spectrum utilization and tradeoffs relative to single-user capacity.

For example, FIG. 6A illustrates an example 600 of a multi-user configuration to increase utilization of cable frequency spectrum in uplink TTIs, when deployed in a TDD mode. In example 600, the multi-user configuration is provided in a frequency region that is configured in a TDD mode, where a downlink configuration includes 12 CCLs that are deployed as 12 component carriers across one layer (e.g., using the FDM configuration shown in FIG. 4F). Furthermore, the frequency region is associated with an uplink configuration that includes 4 CCLs that are deployed as 4 component carriers across one layer. Accordingly, to increase spectrum utilization, the 12 CCLs that support all users for downlink communication may be partitioned into 4 CCLs for a first user group, 4 CCLs for a second user group, and 4 CCLs for a third user group, whereby the full frequency spectrum is utilized (or available to be utilized) during uplink phases of the TDD duty cycle.

Alternatively, FIG. 6B illustrates another example 620 of a multi-user configuration to increase utilization of cable frequency spectrum deployed in a TDD mode during uplink TTIs. In example 620, the multi-user configuration is provided in a frequency region that is configured in a TDD mode, where a downlink configuration includes 12 CCLs that are deployed as 3 component carriers across four layers (e.g., using the FDM configuration shown in FIG. 4D, where all MIMO layers of a component carrier are contiguous or adjacent in spectrum). Additionally, or alternatively, as shown by example 640 in FIG. 6C, the downlink configuration may use the FDM configuration shown in FIG. 4A, where all component carriers associated with the same MIMO layer are contiguous or adjacent in spectrum. Furthermore, in examples 620 and 640, the frequency region is associated with an uplink configuration that includes 4 CCLs that are deployed as 2 component carriers across 2 layers. Accordingly, to increase spectrum utilization, the 12 CCLs that support all users for downlink communication may be partitioned into 2 CCLs for a first user group, 2 CCLs for a second user group, and 2 CCLs for a third user group, where the uplink CCLs associated with each user group include two MIMO layers associated with the same component carrier. For example, the two CCLs associated with each user group are contiguous in FIG. 6B, and the two CCLs associated with each user group are non-contiguous in FIG. 6C (e.g., based on the FDM configuration). In this way, the utilization of the frequency spectrum is increased (or available to be increased) by up to 50% system-wide during uplink phases of the TDD duty cycle relative to a single-user mode (e.g., 6 CCLs are used during uplink phases compared to 4 CCLs in a single-user mode). However, the uplink allocation is limited to the minimum of the number of downlink and uplink layers (e.g., 2 layers in the illustrated example), because correspondence is preserved to the number of component carriers. Furthermore, peak single user throughput decreases by 50% relative to a single-user mode (e.g., 2 CCLs are used by each user group during uplink phases compared to 4 CCLs in a single-user mode). In some cases, some of these limitations may be overcome through suitable configurations (e.g., for users in the first uplink user group, with a PCC at CC0, additional uplink capacity may be configured by configuring CC1 and/or CC2 as uplink SCCs).

In some aspects, in the multi-user TDD configurations shown in FIGS. 6A-6C, a network node may designate one CCL associated with each user group as a PCC (e.g., a CCL associated with a lowest frequency). For example, in the example 600 shown in FIG. 6A, the network node may designate CC0L0, CC4L0, and CC8L0 as a PCC. Alternatively, in the example 620 shown in FIG. 6B and/or the example 640 shown in FIG. 6C, the network node may designate CC0L0, CC1L0, and CC2L0 as a PCC. In some aspects, the network node may configure synchronization signal blocks (SSBs) in the CCLs that are designated to be a PCC to be cell-defining SSBs that are located on one or more global synchronization channel number (GSCN) frequency locations. On all other CCLs, SSBs can be configured at any location and do not need to be on GSCN locations, and a MIB can be reserved or barred on CCLs other than the CCLs designated to be a PCC. Furthermore, a UE or CPE may camp on any of the CCLs that are designated to be a PCC, and a network node may trigger a handover of a CPE or UE in accordance with one or more criteria for redistributing UEs or CPEs to other PCCs. In such cases, the network node may configure the UE or CPE with SCCs (e.g., CC1L0 through CC3L0 in user group 1 in FIG. 6A, or CC0L0 in FIGS. 6B-6C) after the PCC has been reassigned.

As indicated above, FIGS. 6A-6C are provided as an example. Other examples may differ from what is described with regard to FIGS. 6A-6C.

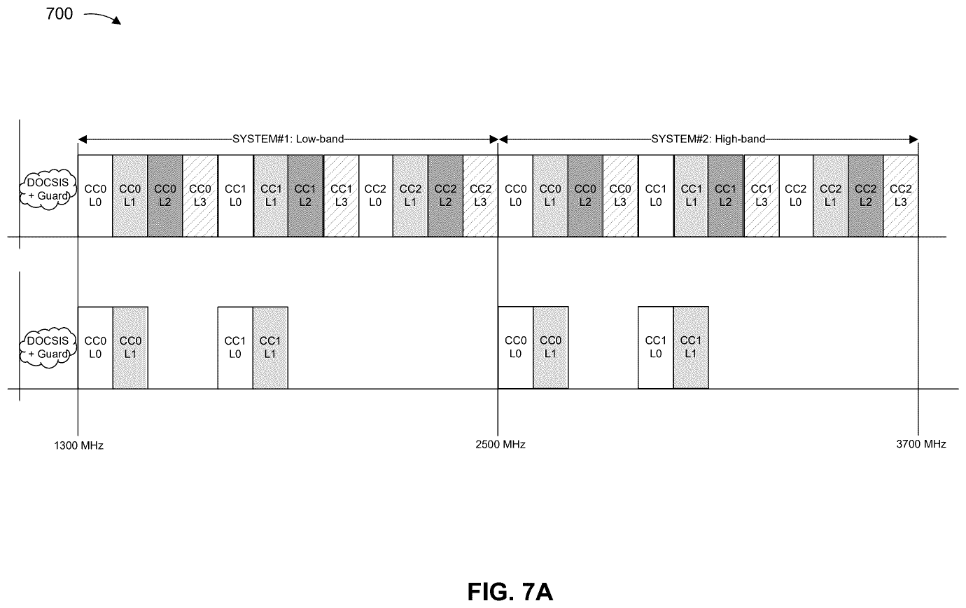

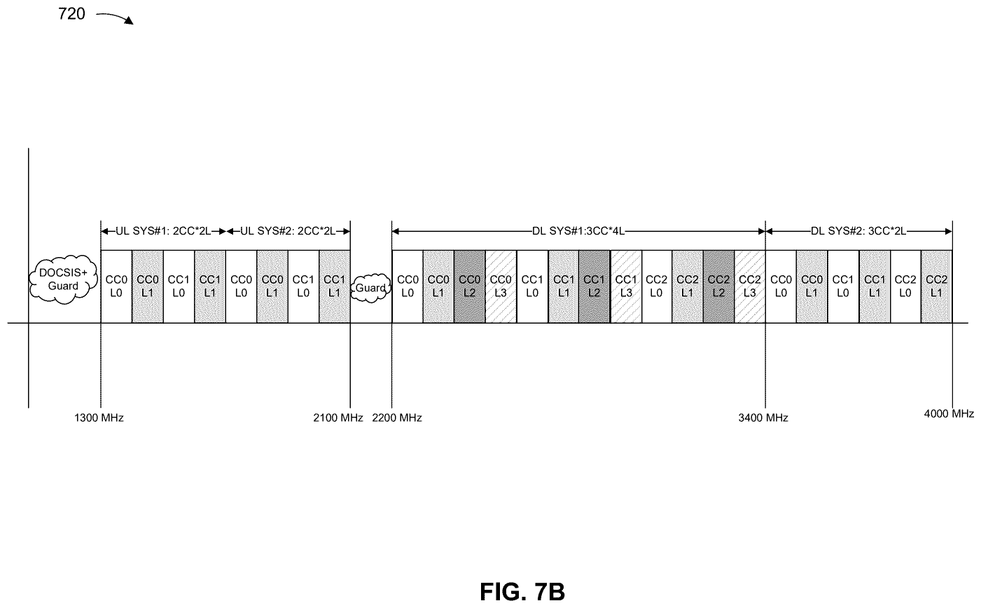

FIGS. 7A-7B are diagrams illustrating examples 700 and 720 associated with multi-system operations to communicate over a cable infrastructure using a RAT. As described herein, an RoC or NRoC system may be deployed using wireless radios, wireless chipsets, RF transceivers, and/or other hardware, software, and/or protocol-based techniques that are designed for wireless communication. Accordingly, one challenge that may arise in an RoC or NRoC system is that the devices used for wireless communication tend to be constrained in terms of envelope support. However, the cable infrastructure may have access to additional frequency spectrum than the wireless chipsets are capable of supporting. Accordingly, in some aspects, utilization of cable frequency spectrum may be increased by deploying multiple systems (or cells) on the cable frequency spectrum.

For example, in some aspects, mobility procedures may be used to transition or handover UEs or CPEs from one system to another in a manner that exploits the pathloss characteristics of the cable frequency spectrum or cable infrastructure. For example, a UE or CPE that is located relatively close to a network node or head-end may report a relatively high RSRP measurement to the network node, which may result in the network node triggering a handover to another system that is operating in a higher frequency region within the cable frequency spectrum (e.g., a high-band system). Similarly, a UE or CPE that is located relatively farther away from a network node or head-end may report a relatively low RSRP measurement to the network node, which may result in the network node triggering a handover to another system that is operating in a lower frequency region within the cable frequency spectrum (e.g., a low-band system). Furthermore, similar load balancing functions may be applied across CCLs that are covered by a single system. For example, a network node may schedule one or more UEs or CPEs that are located closer to the network node (e.g., report higher RSRP measurements) on CCLs that are in a higher frequency region, and may schedule one or more UEs or CPEs that are located farther from the network node (e.g., report lower RSRP measurements) on CCLs that are in a lower frequency region. Furthermore, multi-system operation may be supported with any of the FDM configurations described herein, and may be supported in TDD and FDD deployments.

For example, FIG. 7A illustrates an example 700 of multi-system operations in a TDD deployment, where a first TDD system is deployed in a low-band (lower frequency region) and a second TDD system is deployed in a high-band (higher frequency region). Additionally, or alternatively, FIG. 7B illustrates an example 720 of multi-system operations in an FDD deployment, where a first FDD system includes a first uplink system with 4 CCLs deployed as 2 component carriers across 2 MIMO layers and a first downlink system with 12 CCLs deployed as 3 component carriers across 4 MIMO layers. Furthermore, as shown, a second FDD system includes a second uplink system with 4 CCLs deployed as 2 component carriers across 2 MIMO layers and a second downlink system with 6 CCLs deployed as 3 component carriers across 2 MIMO layers. In example 720, the second downlink system may have a lower capability (e.g., fewer CCLs) than the first downlink system, which may allow the network to fit multiple systems within an allocated portion of the cable frequency spectrum (e.g., a 4 GHz allocation). Furthermore, although FIG. 7B illustrates the downlink system with the higher capability (e.g., more CCLs) in a lower frequency region than the downlink system with the lower capability, the downlink system with the higher capability may be deployed in a higher frequency region than the downlink system with the lower capability. Furthermore, a similar technique (e.g., varying numbers of CCLs) may be applied to multi-system operations in a TDD mode.

As indicated above, FIGS. 7A-7B are provided as an example. Other examples may differ from what is described with regard to FIGS. 7A-7B.

FIG. 8 is a diagram illustrating an example process 800 performed, for example, at a first device or an apparatus of a first device. Example process 800 is an example where the apparatus or the first device (e.g., UE 120 or network node 110) performs operations associated with frequency configurations to communicate over cable infrastructure using a RAT,

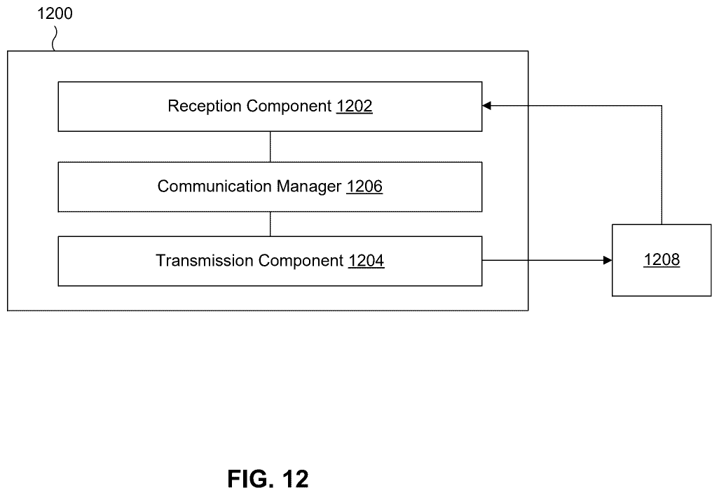

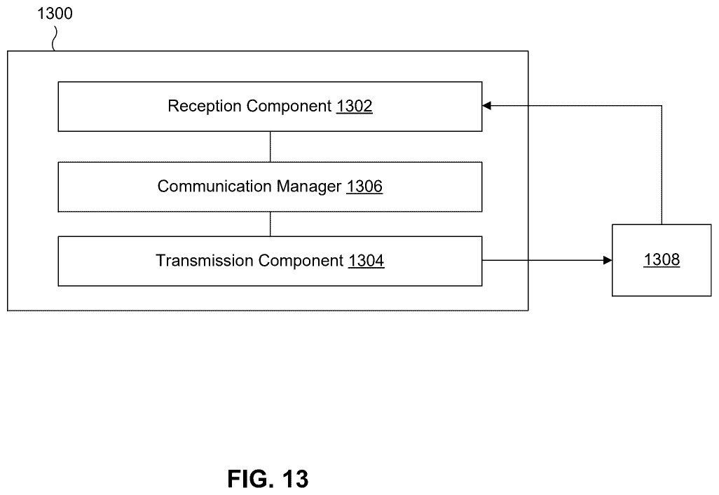

As shown in FIG. 8, in some aspects, process 800 may include determining an FDM configuration for a set of component carriers associated with a cable frequency spectrum, wherein each component carrier in the set of component carriers is associated with a number of MIMO layers (block 810). For example, the first device (e.g., using communication manager 1206, depicted in FIG. 12, or communication manager 1306, depicted in FIG. 13) may determine an FDM configuration for a set of component carriers associated with a cable frequency spectrum, wherein each component carrier in the set of component carriers is associated with a number of MIMO layers, as described above.

As further shown in FIG. 8, in some aspects, process 800 may include communicating with a second device over a cable infrastructure according to the FDM configuration for the set of component carriers (block 820). For example, the first device (e.g., using reception component 1202, transmission component 1204, and/or communication manager 1206, depicted in FIG. 12, or using reception component 1302, transmission component 1304, and/or communication manager 1306, depicted in FIG. 13) may communicate with a second device over a cable infrastructure according to the FDM configuration for the set of component carriers, as described above.

Process 800 may include additional aspects, such as any single aspect or any combination of aspects described below and/or in connection with one or more other processes described elsewhere herein.

In a first aspect, the FDM configuration indicates that all component carriers associated with a particular MIMO layer are adjacent in frequency.

In a second aspect, alone or in combination with the first aspect, the FDM configuration defines a uniform spacing in a frequency domain for the number of MIMO layers.

In a third aspect, alone or in combination with one or more of the first and second aspects, the FDM configuration indicates that all MIMO layers associated with a particular component carrier are adjacent in frequency.

In a fourth aspect, alone or in combination with one or more of the first through third aspects, the FDM configuration associates all component carriers in the set of component carriers with one MIMO layer.

In a fifth aspect, alone or in combination with one or more of the first through fourth aspects, the FDM configuration is associated with an FDD configuration for the set of component carriers.

In a sixth aspect, alone or in combination with one or more of the first through fifth aspects, the FDM configuration is associated with a TDD configuration for the set of component carriers.

In a seventh aspect, alone or in combination with one or more of the first through sixth aspects, process 800 includes exchanging signaling with the second device to establish one or more parameters associated with the FDM configuration.

In an eighth aspect, alone or in combination with one or more of the first through seventh aspects, process 800 includes exchanging signaling with the second device to specify one or more capabilities or configurations associated with communicating over the cable infrastructure.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a first device or an apparatus of a first device. Example process 900 is an example where the apparatus or the first device (e.g., UE 120 or network node 110) performs operations associated with frequency configurations to communicate over cable infrastructure using a RAT.

As shown in FIG. 9, in some aspects, process 900 may include determining an FDD configuration for a cable frequency spectrum, wherein the FDD configuration allocates a first portion of the cable frequency spectrum to downlink communication and allocates a second portion of the cable frequency spectrum to uplink communication (block 910). For example, the first device (e.g., using communication manager 1206, depicted in FIG. 12, or communication manager 1306, depicted in FIG. 13) may determine an FDD configuration for a cable frequency spectrum, wherein the FDD configuration allocates a first portion of the cable frequency spectrum to downlink communication and allocates a second portion of the cable frequency spectrum to uplink communication, as described above.

As further shown in FIG. 9, in some aspects, process 900 may include communicating with a second device over a cable infrastructure according to the FDD configuration for the cable frequency spectrum (block 920). For example, the first device (e.g., using reception component 1202, transmission component 1204, and/or communication manager 1206, depicted in FIG. 12, or using reception component 1302, transmission component 1304, and/or communication manager 1306, depicted in FIG. 13) may communicate with a second device over a cable infrastructure according to the FDD configuration for the cable frequency spectrum, as described above.

Process 900 may include additional aspects, such as any single aspect or any combination of aspects described below and/or in connection with one or more other processes described elsewhere herein.

In a first aspect, the first portion of the cable frequency spectrum allocated to downlink communication includes a set of frequencies that are not reconfigurable for uplink communication.

In a second aspect, alone or in combination with the first aspect, a UE or CPE search space includes a set of frequencies in the first portion of the cable frequency spectrum that are not reconfigurable for uplink communication.

In a third aspect, alone or in combination with one or more of the first and second aspects, the first portion of the cable frequency spectrum allocated to downlink communication includes a set of frequencies that are reconfigurable for uplink communication.

In a fourth aspect, alone or in combination with one or more of the first through third aspects, the first portion of the cable frequency spectrum allocated to downlink communication includes a first set of frequencies that are not reconfigurable for uplink communication and a second set of frequencies that are lower than the first set of frequencies and reconfigurable for uplink communication.

In a fifth aspect, alone or in combination with one or more of the first through fourth aspects, a primary component carrier is deployed in a frequency region, within the first portion of the cable frequency spectrum allocated to downlink communication, that is not reconfigurable for uplink communication.

In a sixth aspect, alone or in combination with one or more of the first through fifth aspects, the second portion of the cable frequency spectrum allocated to uplink communication occupies lower frequencies than the first portion of the cable frequency spectrum allocated to downlink communication.

In a seventh aspect, alone or in combination with one or more of the first through sixth aspects, the first portion of the cable frequency spectrum includes a set of downlink component carrier layers associated with an FDM configuration, and the second portion of the cable frequency spectrum includes a set of uplink component carrier layers associated with the FDM configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with frequency configurations to communicate over cable infrastructure using a RAT.

As shown in FIG. 10, in some aspects, process 1000 may include configuring TDD for a cable frequency spectrum that includes a set of component carrier layers, wherein configuring TDD for the cable frequency spectrum includes allocating respective subsets of the component carrier layers to multiple uplink user groups for uplink communication (block 1010). For example, the network node (e.g., using communication manager 1306, depicted in FIG. 13) may configuring TDD for a cable frequency spectrum that includes a set of component carrier layers, wherein configuring TDD for the cable frequency spectrum includes allocating respective subsets of the component carrier layers to multiple uplink user groups for uplink communication, as described above.

As further shown in FIG. 10, in some aspects, process 1000 may include receiving, from the multiple uplink user groups over a cable infrastructure, uplink transmissions via the respective subsets of the component carrier layers in one or more TTIs that are configured for uplink communication (block 1020). For example, the network node (e.g., using reception component 1302, depicted in FIG. 13) may receive, from the multiple uplink user groups over a cable infrastructure, uplink transmissions via the respective subsets of the component carrier layers in one or more TTIs that are configured for uplink communication, as described above.

Process 1000 may include additional aspects, such as any single aspect or any combination of aspects described below and/or in connection with one or more other processes described elsewhere herein.

In a first aspect, the respective subsets of the component carrier layers allocated to the multiple uplink user groups collectively occupy all of the cable frequency spectrum.

In a second aspect, alone or in combination with the first aspect, the cable frequency spectrum includes one or more frequency regions that are not allocated to any uplink user group for uplink communication.

In a third aspect, alone or in combination with one or more of the first and second aspects, the component carrier layers are contiguous in each subset of the component carrier layers.

In a fourth aspect, alone or in combination with one or more of the first through third aspects, the component carrier layers are non-contiguous in each subset of the component carrier layers.

In a fifth aspect, alone or in combination with one or more of the first through fourth aspects, the respective subsets of the component carrier layers each include a component carrier layer configured as a primary component carrier.

In a sixth aspect, alone or in combination with one or more of the first through fifth aspects, one or more SSBs in the primary component carrier are configured as cell-defining SSBs and located on one or more GSCN locations.

In a seventh aspect, alone or in combination with one or more of the first through sixth aspects, camping is enabled on the primary component carrier.

In an eighth aspect, alone or in combination with one or more of the first through seventh aspects, process 1000 includes transmitting, to a device in one of the multiple uplink user groups over the cable infrastructure, a message triggering a handover to a PCC in a subset of the component carrier layers allocated to a different uplink user group.

In a ninth aspect, alone or in combination with one or more of the first through eighth aspects, process 1000 includes transmitting, to the device over the cable infrastructure, information indicating one or more SCCs in the subset of the component carrier layers allocated to the different uplink user group after the handover is complete.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with frequency configurations to communicate over cable infrastructure using a RAT.

As shown in FIG. 11, in some aspects, process 1100 may include configuring multiple systems in a cable frequency spectrum, wherein the multiple systems are each allocated a respective portion of the cable frequency spectrum (block 1110). For example, the network node (e.g., using communication manager 1306, depicted in FIG. 13) may configure multiple systems in a cable frequency spectrum, wherein the multiple systems are each allocated a respective portion of the cable frequency spectrum, as described above.

As further shown in FIG. 11, in some aspects, process 1100 may include communicating with a user device via a system, of the multiple systems, over a cable infrastructure (block 1120). For example, the network node (e.g., using reception component 1302, transmission component 1304, and/or communication manager 1306, depicted in FIG. 13) may communicate with a user device via a system, of the multiple systems, over a cable infrastructure, as described above.

Process 1100 may include additional aspects, such as any single aspect or any combination of aspects described below and/or in connection with one or more other processes described elsewhere herein.

In a first aspect, process 1100 includes sending, to the user device via the cable infrastructure, a message triggering a handover of the user device to a different system, of the multiple systems, in accordance with one or more parameters that relate to a pathloss associated with the cable infrastructure.

In a second aspect, alone or in combination with the first aspect, communicating with the user device comprises scheduling the user device in a frequency region, within the respective portion of the cable frequency spectrum allocated to the system, in accordance with one or more parameters that relate to a pathloss associated with the cable infrastructure.

In a third aspect, alone or in combination with one or more of the first and second aspects, the respective portions of the cable frequency spectrum allocated to the multiple systems are each associated with an FDM configuration.

In a fourth aspect, alone or in combination with one or more of the first through third aspects, the multiple systems include at least a first system and a second system that are allocated respective portions of the cable frequency spectrum associated with a TDD configuration.

In a fifth aspect, alone or in combination with one or more of the first through fourth aspects, the multiple systems include one or more downlink systems and one or more uplink systems that are allocated respective portions of the cable frequency spectrum associated with an FDD configuration.

In a sixth aspect, alone or in combination with one or more of the first through fifth aspects, the multiple systems include at least a first system allocated a first portion of the cable frequency spectrum that includes a first number of component carrier layers and a second system allocated a second portion of the cable frequency spectrum that includes a second number of component carrier layers.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE or a CPE, or a UE or a CPE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4A-4F, FIG. 5, FIGS. 6A-6C, and/or FIGS. 7A-7B. Additionally, or alternatively, the apparatus 1200 may be configured to perform one or more processes described herein, such as process 800 of FIG. 8, process 900 of FIG. 9, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2. Additionally, or alternatively, the reception component 1202 may include an RF transceiver with one or more narrowband processing units and one or more wideband processing units and/or one or more RF modules, mixers, multiplexers, and/or diplexer and impedance match components external to the RF transceiver, as described in connection with FIGS. 4A-4F.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. Additionally, or alternatively, the transmission component 1204 may include an RF transceiver with one or more narrowband processing units and one or more wideband processing units and/or one or more RF modules, mixers, multiplexers, and/or diplexer and impedance match components external to the RF transceiver, as described in connection with FIGS. 4A-4F. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may determine an FDM configuration for a set of component carriers associated with a cable frequency spectrum, wherein each component carrier in the set of component carriers is associated with a number of MIMO layers. The reception component 1202, the transmission component 1204, and/or the communication manager 1206 may communicate with a second device over a cable infrastructure according to the FDM configuration for the set of component carriers.

The communication manager 1206 may determine an FDD configuration for a cable frequency spectrum, wherein the FDD configuration allocates a first portion of the cable frequency spectrum to downlink communication and allocates a second portion of the cable frequency spectrum to uplink communication. The reception component 1202, the transmission component 1204, and/or the communication manager 1206 may communicate with a second device over a cable infrastructure according to the FDD configuration for the cable frequency spectrum.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4A-4F, FIG. 5, FIGS. 6A-6C, and/or FIGS. 7A-7B. Additionally, or alternatively, the apparatus 1300 may be configured to perform one or more processes described herein, such as process 800 of FIG. 8, process 900 of FIG. 9, process 1000 of FIG. 10, process 1100 of FIG. 11, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 2. Additionally, or alternatively, the reception component 1302 may include an RF transceiver with one or more narrowband processing units and one or more wideband processing units and/or one or more RF modules, mixers, multiplexers, and/or diplexer and impedance match components external to the RF transceiver, as described in connection with FIGS. 4A-4F. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 2. Additionally, or alternatively, the transmission component 1304 may include an RF transceiver with one or more narrowband processing units and one or more wideband processing units and/or one or more RF modules, mixers, multiplexers, and/or diplexer and impedance match components external to the RF transceiver, as described in connection with FIGS. 4A-4F. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may determine an FDM configuration for a set of component carriers associated with a cable frequency spectrum, wherein each component carrier in the set of component carriers is associated with a number of MIMO layers. The reception component 1302, the transmission component 1304, and/or the communication manager 1306 may communicate with a second device over a cable infrastructure according to the FDM configuration for the set of component carriers.

The communication manager 1306 may determine an FDD configuration for a cable frequency spectrum, wherein the FDD configuration allocates a first portion of the cable frequency spectrum to downlink communication and allocates a second portion of the cable frequency spectrum to uplink communication. The reception component 1302, the transmission component 1304, and/or the communication manager 1306 may communicate with a second device over a cable infrastructure according to the FDD configuration for the cable frequency spectrum.

The communication manager 1306 may configure TDD for a cable frequency spectrum that includes a set of component carrier layers, wherein configuring TDD for the cable frequency spectrum includes allocating respective subsets of the component carrier layers to multiple uplink user groups for uplink communication. The reception component 1302 may receive, from the multiple uplink user groups over a cable infrastructure, uplink transmissions via the respective subsets of the component carrier layers in one or more TTIs that are configured for uplink communication.

The communication manager 1306 may configure multiple systems in a cable frequency spectrum, wherein the multiple systems are each allocated a respective portion of the cable frequency spectrum. The reception component 1302, the transmission component 1304, and/or the communication manager 1306 may communicate with a user device via a system, of the multiple systems, over a cable infrastructure.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of communication performed by a first device, comprising: determining an FDM configuration for a set of component carriers associated with a cable frequency spectrum, wherein each component carrier in the set of component carriers is associated with a number of MIMO layers; and communicating with a second device over a cable infrastructure according to the FDM configuration for the set of component carriers.

Aspect 2: The method of Aspect 1, wherein the FDM configuration indicates that all component carriers associated with a particular MIMO layer are adjacent in frequency.

Aspect 3: The method of any of Aspects 1-2, wherein the FDM configuration defines a uniform spacing in a frequency domain for the number of MIMO layers.

Aspect 4: The method of any of Aspects 1-3, wherein the FDM configuration indicates that all MIMO layers associated with a particular component carrier are adjacent in frequency.

Aspect 5: The method of any of Aspects 1-4, wherein the FDM configuration associates all component carriers in the set of component carriers with one MIMO layer.

Aspect 6: The method of any of Aspects 1-5, wherein the FDM configuration is associated with an FDD configuration for the set of component carriers.

Aspect 7: The method of any of Aspects 1-6, wherein the FDM configuration is associated with a TDD configuration for the set of component carriers.

Aspect 8: The method of any of Aspects 1-7, further comprising: exchanging signaling with the second device to establish one or more parameters associated with the FDM configuration.

Aspect 9: The method of any of Aspects 1-8, further comprising: exchanging signaling with the second device to specify one or more capabilities or configurations associated with communicating over the cable infrastructure.

Aspect 10: A method of communication performed by a first device, comprising: determining an FDD configuration for a cable frequency spectrum, wherein the FDD configuration allocates a first portion of the cable frequency spectrum to downlink communication and allocates a second portion of the cable frequency spectrum to uplink communication; and communicating with a second device over a cable infrastructure according to the FDD configuration for the cable frequency spectrum.

Aspect 11: The method of Aspect 10, wherein the first portion of the cable frequency spectrum allocated to downlink communication includes a set of frequencies that are not reconfigurable for uplink communication.

Aspect 12: The method of any of Aspects 10-11, wherein a UE or CPE search space includes a set of frequencies in the first portion of the cable frequency spectrum that are not reconfigurable for uplink communication.

Aspect 13: The method of any of Aspects 10-12, wherein the first portion of the cable frequency spectrum allocated to downlink communication includes a set of frequencies that are reconfigurable for uplink communication.

Aspect 14: The method of any of Aspects 10-13, wherein the first portion of the cable frequency spectrum allocated to downlink communication includes a first set of frequencies that are not reconfigurable for uplink communication and a second set of frequencies that are lower than the first set of frequencies and reconfigurable for uplink communication.

Aspect 15: The method of any of Aspects 10-14, wherein a PCC is deployed in a frequency region, within the first portion of the cable frequency spectrum allocated to downlink communication, that is not reconfigurable for uplink communication.

Aspect 16: The method of any of Aspects 10-15, wherein the second portion of the cable frequency spectrum allocated to uplink communication occupies lower frequencies than the first portion of the cable frequency spectrum allocated to downlink communication.

Aspect 17: The method of any of Aspects 10-16, wherein the first portion of the cable frequency spectrum includes a set of downlink component carrier layers associated with an FDM configuration, and wherein the second portion of the cable frequency spectrum includes a set of uplink component carrier layers associated with the FDM configuration.

Aspect 18: A method of communication performed by a network node, comprising: configuring TDD for a cable frequency spectrum that includes a set of component carrier layers, wherein configuring TDD for the cable frequency spectrum includes allocating respective subsets of the component carrier layers to multiple uplink user groups for uplink communication; and receiving, from the multiple uplink user groups over a cable infrastructure, uplink transmissions via the respective subsets of the component carrier layers in one or more TTIs that are configured for uplink communication.

Aspect 19: The method of Aspect 18, wherein the respective subsets of the component carrier layers allocated to the multiple uplink user groups collectively occupy all of the cable frequency spectrum.

Aspect 20: The method of any of Aspects 18-19, wherein the cable frequency spectrum includes one or more frequency regions that are not allocated to any uplink user group for uplink communication.

Aspect 21: The method of any of Aspects 18-20, wherein the component carrier layers are contiguous in each subset of the component carrier layers.

Aspect 22: The method of any of Aspects 18-21, wherein the component carrier layers are non-contiguous in each subset of the component carrier layers.

Aspect 23: The method of any of Aspects 18-22, wherein the respective subsets of the component carrier layers each include a component carrier layer configured as a PCC.

Aspect 24: The method of Aspect 23, wherein one or more SSBs in the PCC are configured as cell-defining SSBs and located on one or more GSCN locations.

Aspect 25: The method of Aspect 23, wherein camping is enabled on the PCC.

Aspect 26: The method of any of Aspects 18-25, further comprising: transmitting, to a device in one of the multiple uplink user groups over the cable infrastructure, a message triggering a handover to a PCC in a subset of the component carrier layers allocated to a different uplink user group.

Aspect 27: The method of Aspect 26, further comprising: transmitting, to the device over the cable infrastructure, information indicating one or more SCCs in the subset of the component carrier layers allocated to the different uplink user group after the handover is complete.

Aspect 28: A method of communication performed by a network node, comprising: configuring multiple systems in a cable frequency spectrum, wherein the multiple systems are each allocated a respective portion of the cable frequency spectrum; and communicating with a user device via a system, of the multiple systems, over a cable infrastructure.

Aspect 29: The method of Aspect 28, further comprising: sending, to the user device via the cable infrastructure, a message triggering a handover of the user device to a different system, of the multiple systems, in accordance with one or more parameters that relate to a pathloss associated with the cable infrastructure.

Aspect 30: The method of any of Aspects 28-29, wherein communicating with the user device comprises: scheduling the user device in a frequency region, within the respective portion of the cable frequency spectrum allocated to the system, in accordance with one or more parameters that relate to a pathloss associated with the cable infrastructure.

Aspect 31: The method of any of Aspects 28-30, wherein the respective portions of the cable frequency spectrum allocated to the multiple systems are each associated with an FDM configuration.

Aspect 32: The method of any of Aspects 28-31, wherein the multiple systems include at least a first system and a second system that are allocated respective portions of the cable frequency spectrum associated with a TDD configuration.

Aspect 33: The method of any of Aspects 28-32, wherein the multiple systems include one or more downlink systems and one or more uplink systems that are allocated respective portions of the cable frequency spectrum associated with an FDD configuration.

Aspect 34: The method of any of Aspects 28-33, wherein the multiple systems include at least a first system allocated a first portion of the cable frequency spectrum that includes a first number of component carrier layers and a second system allocated a second portion of the cable frequency spectrum that includes a second number of component carrier layers.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A first device for communication, comprising:
one or more memories; and
one or more processors, coupled to the one or more memories, configured to cause the first device to:
determine a frequency division multiplexing (FDM) configuration for a set of component carriers associated with a cable frequency spectrum, wherein each component carrier in the set of component carriers is associated with a number of multiple input multiple output (MIMO) layers; and
communicate with a second device over a cable infrastructure according to the FDM configuration for the set of component carriers.

2. The first device of claim 1, wherein the FDM configuration indicates that all component carriers associated with a particular MIMO layer are adjacent in frequency.

3. The first device of claim 1, wherein the FDM configuration defines a uniform spacing in a frequency domain for the number of MIMO layers.

4. The first device of claim 1, wherein the FDM configuration indicates that all MIMO layers associated with a particular component carrier are adjacent in frequency.

5. The first device of claim 1, wherein the FDM configuration associates all component carriers in the set of component carriers with one MIMO layer.

6. The first device of claim 1, wherein the FDM configuration is associated with a frequency division duplexing configuration for the set of component carriers.

7. The first device of claim 1, wherein the FDM configuration is associated with a time division duplexing configuration for the set of component carriers.

8. The first device of claim 1, wherein the one or more processors are further configured to cause the first device to:
exchange signaling with the second device to establish one or more parameters associated with the FDM configuration.

9. The first device of claim 1, wherein the one or more processors are further configured to cause the first device to:
exchange signaling with the second device to specify one or more capabilities or configurations associated with communicating over the cable infrastructure.

10. A first device for communication, comprising:
one or more memories; and
one or more processors, coupled to the one or more memories, configured to cause the first device to:
determine a frequency division duplexing (FDD) configuration for a cable frequency spectrum, wherein the FDD configuration allocates a first portion of the cable frequency spectrum to downlink communication and allocates a second portion of the cable frequency spectrum to uplink communication; and
communicate with a second device over a cable infrastructure according to the FDD configuration for the cable frequency spectrum.

11. The first device of claim 10, wherein the first portion of the cable frequency spectrum allocated to downlink communication includes a set of frequencies that are not reconfigurable for uplink communication.

12. The first device of claim 10, wherein a user equipment (UE) or customer premises equipment (CPE) search space includes a set of frequencies in the first portion of the cable frequency spectrum that are not reconfigurable for uplink communication.

13. The first device of claim 10, wherein the first portion of the cable frequency spectrum allocated to downlink communication includes a set of frequencies that are reconfigurable for uplink communication.

14. The first device of claim 10, wherein the first portion of the cable frequency spectrum allocated to downlink communication includes a first set of frequencies that are not reconfigurable for uplink communication and a second set of frequencies that are lower than the first set of frequencies and reconfigurable for uplink communication.

15. The first device of claim 10, wherein a primary component carrier is deployed in a frequency region, within the first portion of the cable frequency spectrum allocated to downlink communication, that is not reconfigurable for uplink communication.

16. The first device of claim 10, wherein the second portion of the cable frequency spectrum allocated to uplink communication occupies lower frequencies than the first portion of the cable frequency spectrum allocated to downlink communication.

17. The first device of claim 10, wherein the first portion of the cable frequency spectrum includes a set of downlink component carrier layers associated with a frequency division multiplexing (FDM) configuration, and wherein the second portion of the cable frequency spectrum includes a set of uplink component carrier layers associated with the FDM configuration.

18. A network node for communication, comprising:
one or more memories; and
one or more processors, coupled to the one or more memories, configured to cause the network node to:
configure time division duplexing (TDD) for a cable frequency spectrum that includes a set of component carrier layers, wherein configuring TDD for the cable frequency spectrum includes allocating respective subsets of the component carrier layers to multiple uplink user groups for uplink communication; and
receive, from the multiple uplink user groups over a cable infrastructure, uplink transmissions via the respective subsets of the component carrier layers in one or more transmission time intervals (TTIs) that are configured for uplink communication.

19. The network node of claim 18, wherein the respective subsets of the component carrier layers allocated to the multiple uplink user groups collectively occupy all of the cable frequency spectrum.

20. The network node of claim 18, wherein the cable frequency spectrum includes one or more frequency regions that are not allocated to any uplink user group for uplink communication.
